(19) United States
(12) Patent Application Publication
(10) Pub. No.: US 2025/0307771 A1
(43) Pub. Date: Oct. 2, 2025

(54) Distribution and Feedback Administrator

(71) Applicant: David George Hall, Austin, TX (US)

(72) Inventor: David George Hall, Austin, TX (US)

(21) Appl. No.: 19/097,487

(22) Filed: Apr. 1, 2025

Related U.S. Application Data
(60) Provisional application No. 63/572,613, filed on Apr. 1, 2024.

(51) Int. Cl. G06Q 10/10

(52) U.S. Cl. CPC G06Q 10/10

(57) ABSTRACT

A distribution and feedback administrator (DFA) is described. The DFA is able to generate client-specific content, distribute the content via appropriate channels, and/or provide analytics and/or other feedback. The DFA may provide a dashboard interface that allows a client to manage and/or implement, for example, content (creation and/or distribution), analytics, call tracking, reputation management, social management, and/or support. The DFA may be optimized for use by businesses such as pet care (e.g., veterinarians, groomers, etc.), medical service providers (e.g., dentists, chiropractors, physical therapists, optometrists, psychologists, psychiatrists, plastic surgeons, acupuncturists, etc.), other professional service providers (e.g., attorneys, accountants, real estate agents, etc.), construction and maintenance service providers (e.g., home builders, contractors, auto mechanics, etc.), venues or establishments (e.g., restaurants, bars, music venues, etc.), retailers (e.g., boutiques, clothing stores, shoe stores, etc.), beauty and wellness services (e.g., hair salons, nail salons, day spas, etc.), and/or other types of business.

### CROSS-REFERENCE TO RELATED APPLICATIONS

This application claims priority to U.S. Provisional Patent Application Ser. No. 63/572,613, filed on Apr. 1, 2024.

### BACKGROUND OF THE INVENTION

Many business owners wish to engage potential clients or customers via different platforms (e.g., social media platforms, web sites, directories, etc.). Generating and/or distributing content to potential clients or customers can be difficult, cumbersome, and ineffective.

Thus, there exists a need for ways to automate the creation of content and distribution thereof.

### BRIEF DESCRIPTION OF DRAWINGS

The novel features of the disclosure are set forth in the appended claims. However, for purposes of explanation, several embodiments are illustrated in the following drawings.

FIG. 1 illustrates an example overview of one or more embodiments described herein, in which a distribution and feedback administrator (DFA) of some embodiments is provided to a client via a dashboard of some embodiments;

FIG. 2 illustrates a data structure diagram of one or more embodiments described herein;

FIG. 3 illustrates a schematic block diagram of an environment of one or more embodiments described herein;

FIG. 4 illustrates a flow chart of an exemplary process that collects and analyzes client information;

FIG. 6 illustrates a flow chart of an exemplary process that provides a dashboard of some embodiments;

FIG. 5 illustrates a flow chart of an exemplary process that performs industry analysis some embodiments;

FIG. 7 illustrates a flow chart of an exemplary process that generates content for a client;

FIG. 8 illustrates a flow chart of an exemplary process that generates an interview script of some embodiments;

FIG. 9 illustrates a flow chart of an exemplary process that manages social engagement in some embodiments;

FIG. 10 illustrates a flow chart of an exemplary process that performs machine learning in some embodiments; and

FIG. 11 illustrates a schematic block diagram of one or more exemplary devices used to implement various embodiments.

### DETAILED DESCRIPTION OF THE INVENTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a distribution and feedback administrator (DFA) that is able to generate client-specific content, distribute the content via appropriate channels, and/or provide analytics and/or other feedback. In some embodiments, the DFA may provide an interface (e.g., a dashboard) that may allow a client-user to manage and/or implement, for example, content (creation and/or distribution), analytics, call tracking, reputation management, social management, and/or support.

The DFA may be optimized in some embodiments for use by local businesses such as pet care (e.g., veterinarians, groomers, etc.), medical service providers (e.g., dentists, chiropractors, physical therapists, optometrists, psychologists, psychiatrists, plastic surgeons, acupuncturists, etc.), other professional service providers (e.g., attorneys, accountants, real estate agents, etc.), construction and maintenance service providers (e.g., home builders, contractors, HVAC contractors, landscaping contractors, auto mechanics, etc.), venues or establishments (e.g., restaurants, bars, music venues, etc.), retailers (e.g., boutiques, clothing stores, shoe stores, etc.), beauty and wellness services (e.g., hair salons, nail salons, day spas, etc.), and/or other types of business, venues, and/or establishments. In some embodiments, the DFA may be optimized for any local business or service provider where clients or customers typically want to work with or shop from a provider within twenty miles of their home or business.

The DFA may be specifically implemented and/or optimized for each type of business or provider. Such optimization may entail numerous customizations for each industry to ensure that the DFA correctly identifies the various types of products and services commonly offered by professionals within that industry. The optimization may include significant industry specific customizations based on research into the customer journey as it relates to the needs, benefits, and considerations of customers relating to the products and services provided via that industry. This industry-specific research may then inform strategic feedback and implementation policies provided via, and/or implemented by, the DFA.

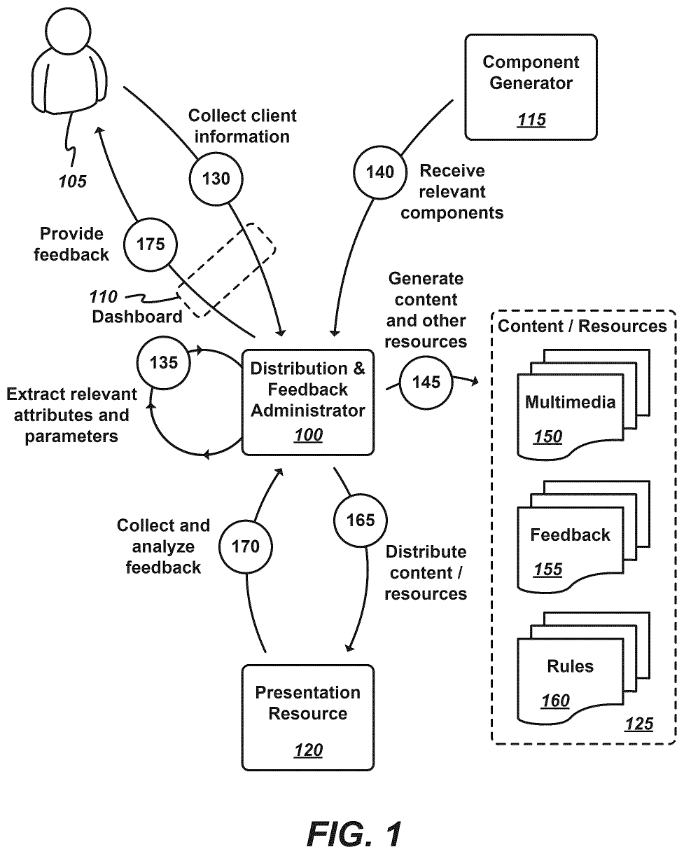

FIG. 1 illustrates an example overview of one or more embodiments described herein, in which a DFA 100 of some embodiments is provided to a client 105 via a dashboard 110 of some embodiments. In this example, DFA 100 may interact with client 105 (via dashboard 110), component generator 115, presentation resources 120, and/or other appropriate components, devices, or systems (e.g., a storage for content and/or resources 125).

DFA 100 may be, include, and/or utilize, various devices, components, systems, etc. that may be able to implement the various functionalities described herein. DFA 100 may be able to execute instructions and/or otherwise process data. DFA 100 may be able to generate, store, and/or receive information such as data structures (e.g., databases, lookup tables, etc.), profiles (e.g., client and/or other user profiles, establishment or venue profiles, business profiles, provider profiles, etc.), commands and/or instructions (e.g., messages to other components, systems, and/or devices that may include commands or instructions to be executed or otherwise implemented by the other components, systems, and/or devices), generate user interfaces (e.g., a dashboard implemented via a graphical user interface of some embodiments), user inputs or selections, etc.

Client or “client-user” 105 may be a user or other entity associated with a business, venue, establishment, etc. For example, a client-user 105 may be a business owner or administrator who may access the DFA 100 via a user device such as a smartphone, tablet, or personal computer (not shown). As another example, a client 105 may be a device, system, component, or similar resource that may provide relevant information to DFA 100 and/or otherwise interact with DFA 100. Client-users 105 (and/or other types of users) may be required to provide credentials (e.g., a username and password, an access key, etc.) to access the DFA 100. Once authenticated or verified (e.g., by using a lookup table to identify an entry associated with the username and determine whether the provided password matches that indicated by the entry), the client 105 is automatically logged in to relevant sub-platforms (e.g., those to which the client 105 has subscribed or otherwise enabled).

Dashboard 110 may be, include, utilize, and/or otherwise enable a portal that may allow clients 105 to access various sub-platforms of the DFA 100. As an example, in some embodiments, the dashboard 100 may provide access to sub-platforms such as “content”, “analytics”, “call tracking”, “reputation management”, “social management”, and “support”. One of ordinary skill in the art will recognize that various other sub-platforms may be provided and/or various listed sub-platforms may be omitted in some embodiments. The dashboard 110 may be implemented via resources such as web pages, smart device apps, and/or other appropriate interfaces (e.g., an audio interface). The various sub-platforms may be able to share information, instructions, policies, rules, and the like and/or may be otherwise integrated (e.g., feedback from one sub-platform may be provided to another sub-platform).

The content sub-platform may provide, utilize, and/or otherwise implement strategy (e.g., by implementing one or more rules or policies, by utilizing one or more machine learning models, etc.), customizations, and resources that are uniquely optimized for each industry and/or profession. The content sub-platform may set the foundation for all of the strategies implemented by each of the other sub-platforms of the DFA 100. The DFA 100, via the content sub-platform and/or dashboard 110, may identify every product and/or service provided by a particular industry and/or professionals associated therewith. After identifying all the products and services, thorough keyword and frequently asked question (FAQ) research may be conducted via various appropriate methodologies and platforms to identify the words, phrases, and questions that people use to search for information related to each topic.

FAQs, keywords, and/or other relevant information may be filtered or ranked in various ways. For instance, if a search of relevant industry resources (e.g., popular websites) indicates that some phrases or keywords are used in by a high proportion of the industry resources (and/or used multiple times by each resource), those phrases or keywords may be associated with a higher score or ranking than phrases or keywords that are used by a lower proportion of resources (and/or less frequently within each resource). FAQs, keywords, and/or other relevant information may be associated in various appropriate ways in some embodiments. For example, if a first keyword is often used in conjunction with a second keyword, the keywords may automatically be combined by the DFA 100 to form a multi-keyword phrase.

Once the keyword and FAQ research is complete, customer journey research may be performed to identify all of the stages that customers encounter and potential touch points for industry professionals to support people as they proceed through, for example, awareness, education, consideration, engagement, purchase, support, ongoing relationship, and advocacy. Each of these high-level stages may include a variety of potential actions that a person could commonly take, and these are considered potential touch points. A foundational part of the DFA 100 implementation involves the identification of such potential touch points and the generation of specific content strategies that may be used to support people at each specific stage in their customer journey. For example, an e-commerce site may be evaluated to identify, for example, resources such as landing pages, product pages, shopping or checkout pages, etc. Customer analytics data may be analyzed to determine how a typical customer proceeds through each resource and/or which resources are associated with each stage or potential touch point. Thus, for example, a touch point may be identified when a customer performs (or is provided with the opportunity to perform) a search on an e-commerce website, navigation to a product page, adding a product to a shopping cart, posting a review, etc.

The content sub-platform may include, provide, generate, and/or otherwise utilize interview scripts. Based on the keyword and FAQ research, interview scripts that provide a high-level overview of each topic related to the products and services related to the industry may be generated. The interview script may incorporate the most relevant FAQs identified during research (e.g., based on number of views, user feedback, and/or other relevant metrics). A variety of interview scripts may be generated so that each topic includes scripts with varying attributes (e.g., length or number of FAQs, portion dedicated to various sub-topics or niches within the main topic, order of FAQs, etc.). The interview scripts may be provided to clients 105 (e.g., via text or audio prompts) such that the clients 105 may easily record responses indicating capabilities, professional opinions and/or recommendations, and/or other relevant information for each FAQ or topic. Such an approach enables clients 105 to easily create content that supports the keywords and questions that their target audience is using most when looking for information related to these topics.

The content sub-platform may include, provide, generate, and/or otherwise utilize content libraries of service pages. The service pages may include or otherwise utilize video submissions from other clients 105 associated with the industry as an expert interview on the topic and from that interview a professionally written product or service page may be generated and added to the content library for other clients 105 to utilize. These product/service library pages may feature a significant amount of tokenization where text snippets representing the information of a specific client 105 may be automatically inserted, thus customizing the content to make it highly relevant to a specific client 105 for use by a presentation resource 120.

The content sub-platform may include, provide, generate, and/or otherwise utilize a blog post library covering topics based on the products and services content research with information based on, for example, interviews of industry professionals or written and reviewed by an industry professional. The blog posts may feature a significant amount of tokenization where text snippets representing the information of a specific client 105 may be automatically inserted, thus customizing the content to make it highly relevant to a specific client 105 for use by a presentation resource 120.

The content sub-platform may include, provide, generate, and/or otherwise utilize a library of content resources that support deep subtopics related to products and services, along with content that can be used in marketing as downloadable information for clients or customers of the client 105 or otherwise shared via presentation resources 120. The resource pages feature a significant amount of tokenization where text snippets representing the information of a specific client 105 may be automatically inserted, thus customizing the content to make it highly relevant to a specific client 105 for use by a presentation resource 120.

The analytics sub-platform may include, provide, generate, and/or otherwise utilize a variety of analytics tools, including, for example, website analytics and/or pay per click (PPC) analytics. Website analytics may provide feedback related to metrics that may be based on a combination of common website performance indicators reported over selected time periods including but not limited to total website sessions, unique visitors, pages per visit, average engagement time per visit, traffic sources, landing pages, page visits, and/or other appropriate and relevant metrics. PPC analytics may provide feedback related to metrics that are based on a combination of common PPC advertising campaign performance indicators reported over selected time periods. PPC management services may include campaigns that are optimized to support the topic, keyword, and question research conducted in the strategic development of the content libraries.

The call tracking sub-platform may use call tracking numbers assigned to the client 105 to track the number of inbound phone calls, record the calls, and/or collect various metrics related to the calls, such as the time the call was initiated and the duration of the call. Clients 105 may be able to listen to call recordings, flag calls for review, and/or otherwise interact with the call tracking information.

The reputation management sub-platform may allow clients 105 to perform key functions related to managing the online reputation of the business.

The reputation management sub-platform may provide access to a directory profiles service that identifies existing business listings or profiles provided via various business directories and attempt to claim the existing business listings on behalf of the client 105 and ensure that, for example, demographic information such as the business name, address, and phone number on each profile is accurate.

The reputation management sub-platform may provide access to a review management feature that may monitor the top online business and review profiles across a set of online business directories that is identified as relevant for each industry and profession. The review management feature may monitor reviews and provide high level metrics such as, for example, average star rating and number of reviews. The reputation management sub-platform may provide all reviews across a selection of review platforms and present the reviews on a single page so that clients 105 can easily see their reviews and take action to respond to those reviews from a centralized location.

The social management sub-platform may allow clients 105 to perform key functions related to managing the social media presence of the business.

The social management sub-platform may provide access to a library of social posts based on the product and service topic research, and the customer journey research that informed the content libraries. Each topic may be analyzed through the lens of different social post types including but not limited to photos, videos, contests, infographics, memes, answers to FAQs, holidays, and business announcements. The social post library may include an inspiration library which provides inspirational recommendations for social post content that the client 105 may choose to create on their own, along with professionally designed social posts that clients 105 may choose to post to their own social profiles.

The social management sub-platform may provide access to a tool that allows clients 105 to post via the dashboard 110 (and DFA 100) to their preferred social networks, customize each post accordingly, and schedule the post to be published at a date and time of their choosing.

The social management sub-platform may provide access to a tool that allows clients 105 to monitor comments to their social posts and provide the ability to respond to those social posts directly via the DFA 100.

The social management sub-platform may provide access to social profile analytics. The DFA 100 may monitor analytics metrics that are common to each individual social network to track metrics including but not limited to post frequency, post types, and post engagement.

The support sub-platform may provide access to a support knowledgebase that may provide Instructions on how to utilize each component of the marketing portal and its constituent platforms will be provided in a knowledgebase along with answers to FAQs.

Each component generator 115 may be, include, and/or utilize one or more devices, components, and/or systems that are able to provide information or content to DFA 100. Such information and/or content may include, for instance, listings of FAQs, review information, profile or advertising information, templates such as blog post templates or social media post templates, etc. Component generators 115 may include, utilize, and/or provide access to resources such as external servers, databases, etc. For instance, DFA 100 may receive engagement information from a social media database via a component generator 115 (e.g., a server associated with the social media site).

Content and/or other data provided via a component generator 115 may be filtered and/or modified by DFA 100 as appropriate. For instance, a component generator 115 may provide multimedia blog post templates that may include or reference graphics, images, audiovisual content, etc. In addition, such a template may include various tokenized elements or fields. In such cases, information or content specific to the client 105 may be used to modify the template for presentation. For instance, tokenized elements (e.g., business name) may be replaced by the data associated with the client 105 (e.g., “ABC Company”). As another example, a video stream element (e.g., a section of a blog GUI) may be modified to utilize client-specific content (e.g., video of the client 105 answering a FAQ). As still another example, an image associated with a blog post may be replaced by a client-specific image (e.g., a placeholder image may be replaced by a profile photo of the business owner).

The component generator 115 may be a sub-component of DFA 100 in some embodiments. The component generator 115 may be, include, and/or utilize one or more external or remote resources in some embodiments (e.g., a third-party server or application programming interface (API)).

Each presentation resource 120 may be a device, component, or system that is able to provide content to consumers (and/or otherwise interact with consumers). In some cases, a presentation resource 120 may be, include, and/or utilize content or other information that may be provided via another resource. For instance, a presentation resource 120 may be a website, email, or social post that includes content generated via DFA 100.

As shown in the example of FIG. 1, DFA 100 may collect (at 130) client information from client 105 (and/or other appropriate resources) via the dashboard 110. Such client information may include information such as industry, goods and/or services, provider information, etc. Attributes such as industry may be identified in various appropriate ways (e.g., client 105 may make a selection from a listing of discrete choices, client 105 may provide an industry code or other identifier, etc.). DFA 100 may receive various sets of questions or information fields that may be utilized to collect industry-specific and/or other information from the client 105. For example, if the client 105 selects “veterinary services” as the industry, the DFA 100 may prompt the client 105 to indicate from a list the types of animals to which the client 105 provides services (e.g., dogs, cats, rabbits, horses, livestock, etc.). As another example, the client 105 may be able to indicate hours of operation, certifications or licenses, and/or other relevant information. Collected client information may include client preferences or settings. For example, a client 105 may be able to indicate which types of content the client 105 would like to generate and/or distribute (e.g., a client 105 may want to generate video clips but not blog posts, while another client 105 may want to distribute social media posts but not video clips).

DFA 100 may extract (at 135) relevant attributes and parameters from the received client information. For example, a set of keywords, FAQs, etc. may be generated based on the client information (e.g., industry, location, services provided, etc.). In some cases, feedback may be received from the client 105 regarding the extracted attributes and parameters (e.g., a client 105 may indicate that certain keywords are relevant while others are not, and/or set a priority or order that defines a relative weighting of each keyword).

Based on the relevant attributes and parameters, DFA 100 may receive relevant components from one or more component generators 115. Relevant components may include, for instance, FAQs, templates (e.g., blog post or social media post templates), and/or other information that may be utilized by DFA 100 to generate (at 145) content and/or other resources 125 such as multimedia 150, feedback 155, rules 160, and/or other appropriate elements (e.g., machine learning models).

Multimedia 150 may include elements such as text, graphics, video, audio, images, and/or animations. Examples of multimedia 150 may include captured video of a provider answering a FAQ, text including a description of various services, a web page (or portion thereof) including information related to the client 105, etc.

Feedback 155 may include information such as collected analytic data, direct feedback from consumers (e.g., review information), indirect feedback from consumers (e.g., whether a consumer who viewed a product information page ultimately purchased the product), and/or other relevant feedback.

Rules 160 may include, implement, and/or otherwise utilize policies associated with an industry or client 105 to optimize performance of the DFA 100. Rules 160 may include utilization of machine learning models to identify, for example, relevant attributes and parameters associated with the business of a client 105. Rules 160 may be used to indicate where and/or how content should be distributed and/or what types of content should be generated and/or enabled. For instance, based on selections received from a client 105, a rule 160 may indicate which directories or listings are of interest in identifying FAQs. As another example, a rule 160 may indicate that a certain type of content (e.g., video) has positive results for a particular industry, but that another type of content (e.g., text-based information) is not associated with positive results for that particular industry. As another example, a set of rules 160 may define how client-specific information is applied to various templates.

DFA 100 may distribute (at 165) the content and/or resources 125 to various presentation resources 120 for delivery to potential clients and/or consumers. Such distribution may utilize rules 160 to identify presentation resources 120 for items such as multimedia 150. For example, video content may be distributed via different presentation resources 120 than audio content. As another example, multimedia 150 such as an email may be distributed to a mailing list provided by the client 105 and implemented via a set of rules 160.

DFA 100 may collect and analyze (at 170) feedback 155 via presentation resources 120. Such feedback may include, for example, analytics information, purchase or booking information, review information, etc.

DFA 100 may provide (at 175) the feedback via the dashboard 110. In some embodiments, DFA 100 may analyze received feedback to make recommendations to the client 105 via dashboard 110. For example, DFA 100 may indicate that video snippets have produced more engagements than blog posts.

Throughout this disclosure, various features and components may be described by reference to specific example implementations. For instance, many examples may refer to veterinary services. However, one of ordinary skill in the art will recognize that the features and components described herein may be applied to various other types of providers, establishments, retailers, etc.

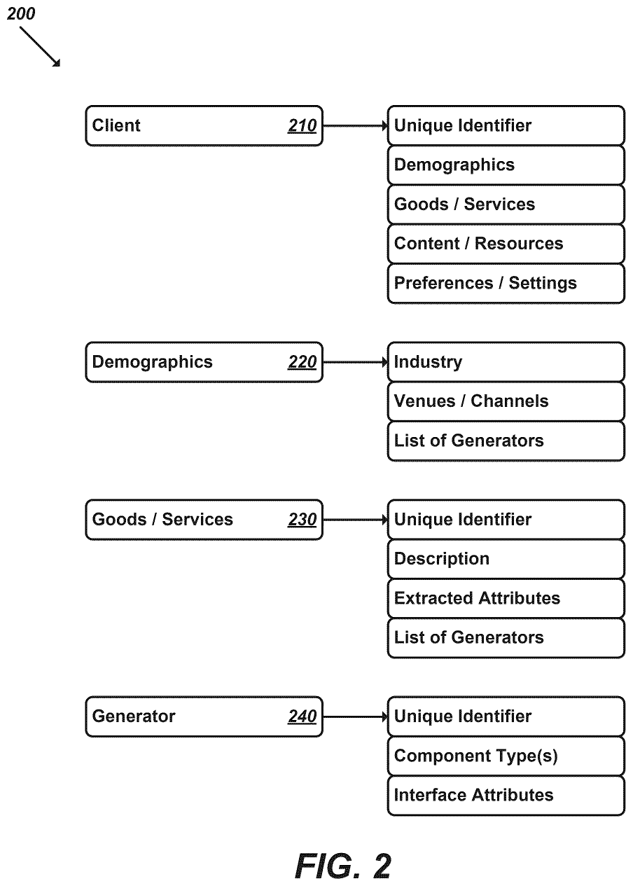

FIG. 2 illustrates a data structure diagram 200 of one or more embodiments described herein. As shown, data structures may include a client element 210, demographics element 220, a goods and/or services element 230, and a generator element 240. For clarity and conciseness, the number of elements is limited in this example, but one of ordinary skill in the art would recognize that data structures used by some embodiments of DFA 100 may include various other elements (e.g., a presentation resource element, a rule element, a machine learning model element, multimedia element, feedback element, rule element, etc.) and/or sub-elements. Likewise, in some embodiments, various listed elements and/or sub-elements may be omitted or otherwise not utilized by DFA 100.

As shown, in this example client element 210 may include sub-elements such as a unique identifier (e.g., a serial number, user ID, etc.), demographics (e.g., a reference to one or more demographics elements 220), goods and/or services (e.g., a reference to one or more goods and/or services elements 230), content and/or resources (e.g., references to components such as multimedia content, templates, implementation rules, etc.), preferences and/or settings (e.g., those associated with previous client selections and/or feedback), and/or other appropriate sub-elements.

Demographics element 220 may include sub-elements such as an industry or reference thereto (e.g., a code or other identifier that refers to an industry data element, not shown), venues and/or channels (e.g., a list of sales platforms, directories, establishment locations, etc. associated with the client 105), a list of content generators (e.g., websites, journals, industry professionals, etc.), and/or other appropriate elements.

Goods and/or services element 230 may include sub-elements such as a unique identifier, a description of the goods and/or services, extracted attributes (e.g., codes or identifiers, keywords, etc.), and a list associated of associated content generators.

Generator element 240 may be associated with a component generator 115 and may include sub-elements such as a unique identifier, component type (e.g., text, video, audio, FAQ, etc.), and interface attributes (e.g., messaging protocols or API information associated with the component generator 115).

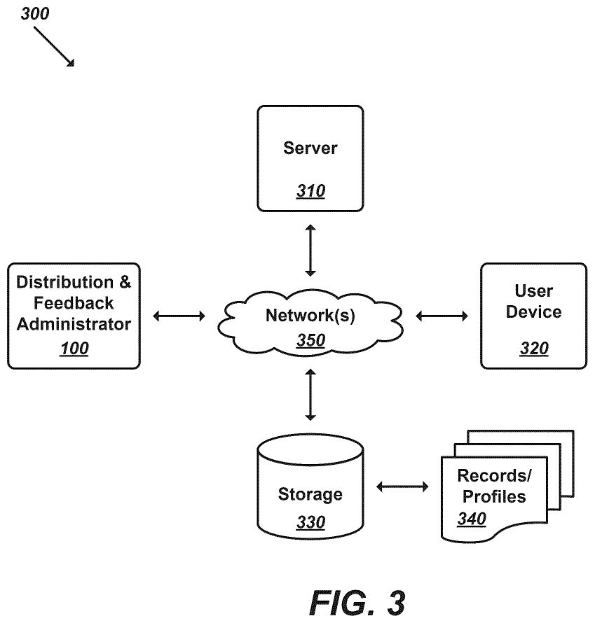

FIG. 3 illustrates a schematic block diagram of an environment 300 of one or more embodiments described herein. As shown, environment 300 may include DFA 100, server 310, user devices 320, storage 330, records and/or profiles 340, network(s) 350, and/or other appropriate elements, components, devices, and/or systems.

DFA 100 may be, include, utilize, and/or otherwise be associated with a set of electronic components, devices, systems, and/or other appropriate elements. DFA 100 may include one or more processors that are able to execute instructions and/or otherwise manipulate data. DFA 100 may be able to communicate via networks 350. DFA 100 may be at least partially implemented using a device such as device 1100 described below. DFA 100 may be able to direct, and/or otherwise utilize, components of other devices or systems. For instance, DFA 100 may provide various graphical user interfaces (GUIs) via a display of user device 320. DFA 100 may utilize data structures such as those described in reference to data structure diagram 200.

Each server 310 may be, include, and/or utilize an electronic device, component, or system that is able to execute instructions and/or otherwise process data. Server 310 may provide information related to consumer engagements, analytics, and/or other relevant information.

Each user device 320 may be a device such as a smart phone, tablet, personal computer (PC), laptop, wearable device (e.g., a smart watch), and/or other type of device that allows user interaction with environment 300. User device 320 may be able to communicate via network 350. User device 320 may typically include various UI elements (e.g., a display, keypad, buttons, touchscreen, etc.) that may be used to provide information and/or instructions to a user and/or receive information, commands, and/or instructions from a user. Dashboard 110 (and/or other access to DFA 100) may be provided to client 105 via user device 320.

In some cases, user devices 320 (and/or features described in association therewith) may be implemented via other components of environment 300. For instance, DFA 100 may have various available UI features (e.g., displays, keypads, buttons, controllers, LEDs, lights or other indicators, etc.) that may be utilized in a comparable manner to a user device 320. User device 320 may be implemented using a device similar to device 1100 described below.

Storage 330 may be a device, component, system, and/or other appropriate element(s) that may be able to store data and/or instructions and provide such data and/or instructions to other components of environment 300. In this example, storage 320 may include records and/or profiles 340 (and/or references thereto). Examples of such records and profiles 340 will be described in reference to data structure diagram 200. In some embodiments, storage 330 may be accessible via an API.

Network(s) 350 may include various communication pathways, such as cellular networks, satellite-based systems, radio communication channels, optical communication channels, peer-to-peer communication channels, and/or any other available communication pathways. Information such as client inputs or selections, machine learning models, content resources, and/or other relevant information may be communicated across network(s) 350.

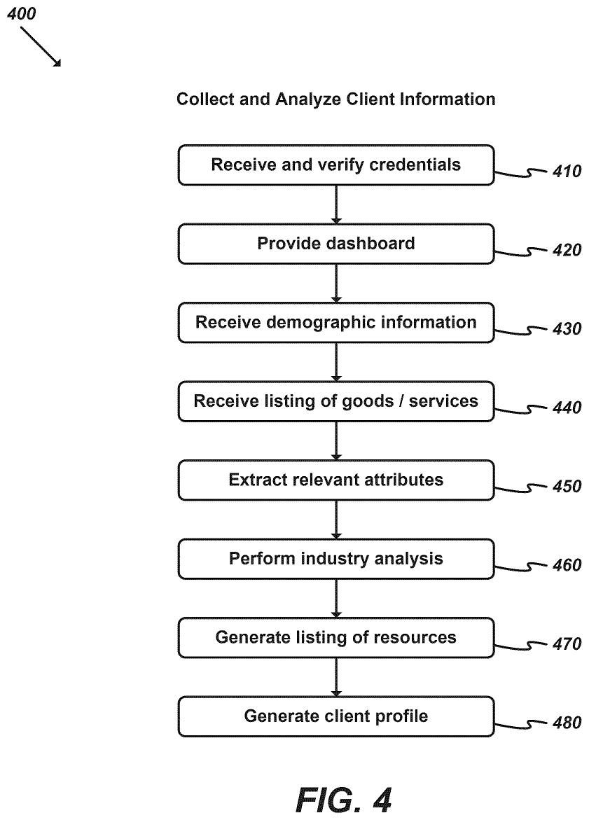

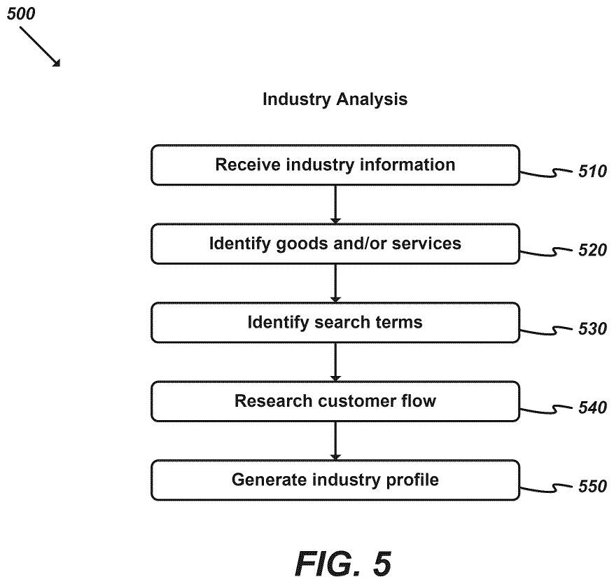

FIG. 4 illustrates an example process 400 for collecting and analyzing client information. The process 400 may allow collection and analysis of information from new and existing clients 105. The process 400 may be performed whenever a client 105 accesses the DFA 100. In some embodiments, process 400 may be performed by DFA 100, and may be implemented via dashboard 110.

As shown, process 400 may include receiving and verifying (at 410) credentials. Such credentials may include, for example, a username and password, an API key, etc. If the credentials are not able to be verified or authenticated the user may be denied access to the DFA 100. In some embodiments, default credentials or saved information (e.g., a cookie) may allow clients 105 access to the DFA 100 without requiring a password or key.

Process 400 may include providing (at 420) a dashboard 110 of some embodiments. The dashboard 110 may be provided via a resource such as a web site or user device app. The dashboard 110 may utilize a GUI that provides information to a client 105 and is able to receive data from the client 105.

The process 400 may include receiving (at 430) demographic information associated with the client 105. Demographic information may be received via the dashboard 110 and may include, for example, industry, location(s), hours of operation, content (e.g., taglines or mottos), and/or other appropriate information.

As shown, process 400 may include receiving (at 440) a listing of goods and/or services provided via the client 105. The listing of goods and/or services may be received via dashboard 110 and may include an identifier for each good or service, description of the good or service, pricing information, manufacturer or supplier information, warranty information, and/or other relevant information. In some embodiments, DFA 100 may generate a list of available goods and/or services for the specified industry and receive selections from the client 105 indicating which goods and/or services are offered. As another example, a client 105 may be able to search a library of goods and/or services to identify goods and/or services to be included in the listing.

Process 400 may include extracting (at 450) relevant attributes associated with the goods and/or services. Such attributes may include information related to, for example, type, cost, popularity, etc.

The process 400 may include performing (at 460) industry analysis. Such industry analysis will be described in more detail in reference to process 500 below.

As shown, process 400 may include generating (at 470) a listing of relevant resources. The listing of resources may include references to relevant and appropriate component generators 115, presentation resources 120, etc.

Process 400 may include generating (or updating) (at 480) a client profile. The client profile may include the information associated with the client 105, such as credentials, industry, listing of goods and/or services, preferences or settings, etc. The client profile may be stored by DFA 100 such that the profile is accessible whenever the client 105 accesses the DFA 100 and/or profile information is otherwise relevant (e.g., when the DFA 100 selects presentation resources 120 to which to distribute content).

FIG. 5 illustrates an example process 500 for performing industry analysis in some embodiments. The process 500 may identify relevant industry information, such as consumer flow (e.g., a listing of touch points), associated goods and/or services, listings of providers, etc. The process 500 may be performed at element 460 of process 400. In some embodiments, process 500 may be performed by DFA 100.

As shown, process 500 may include receiving (at 510) industry information. Such industry information may include, for example, an industry code or other unique identifier that may refer to an industry profile element (or similar data structure). Industry information may include references to providers, sales channels, and/or other relevant information.

Process 500 may include identifying (at 520) goods and/or services associated with the industry. In some embodiments, DFA 100 may utilize a lookup table or other database to identify goods and/or services associated with the industry. For example, a lookup table may include an entry for each industry, where each entry references a set of associated goods and/or services.

The process 500 may include identifying (at 530) search terms associated with the goods and/or services. Search terms may be identified using a lookup table or database, similar to the identification of goods and/or services. In some embodiments, search terms may be identified via external resources, such as search engines, social media platforms, e-commerce sites, directory listings, etc.

As shown, process 500 may include researching (at 640) customer flow associated with the industry. The identified search terms may be utilized to determine customer flow (e.g., a listing touch points) via resources such as a database maintained by DFA 100 and/or external resources such as search engines, social media platforms, ecommerce sites, directory listings, etc.

Process 500 may include generating (at 550) an industry profile. The industry profile may include, or refer to, information such as associated providers or retailers, goods and/or services, location(s), customer flow, etc.

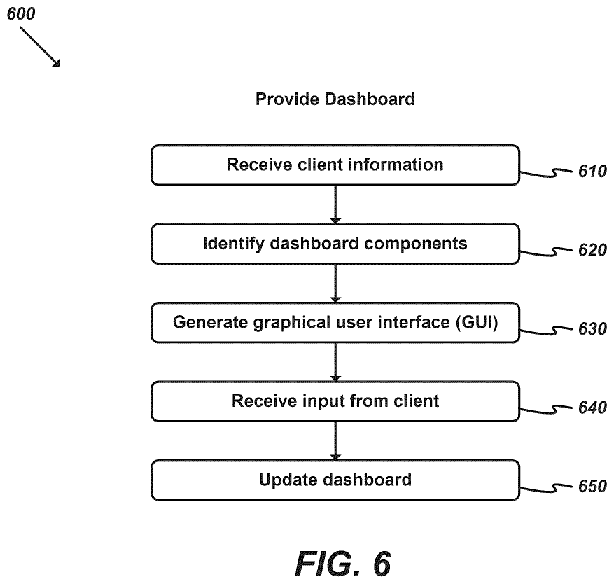

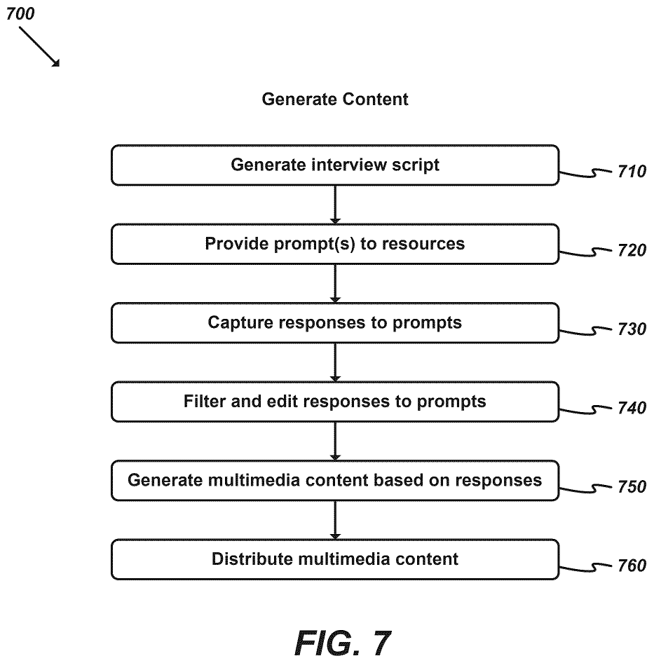

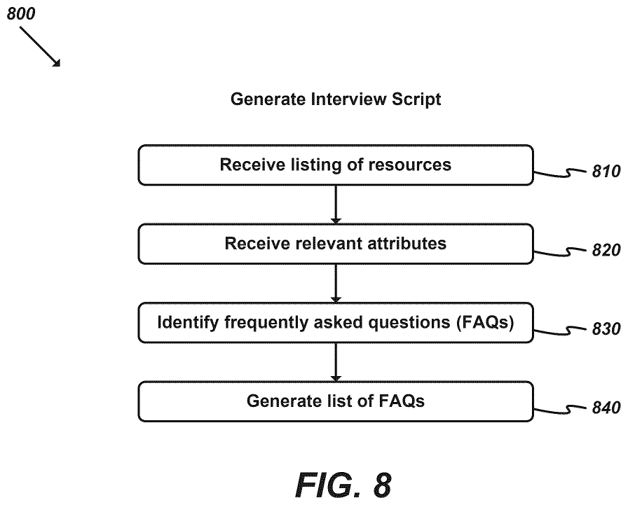

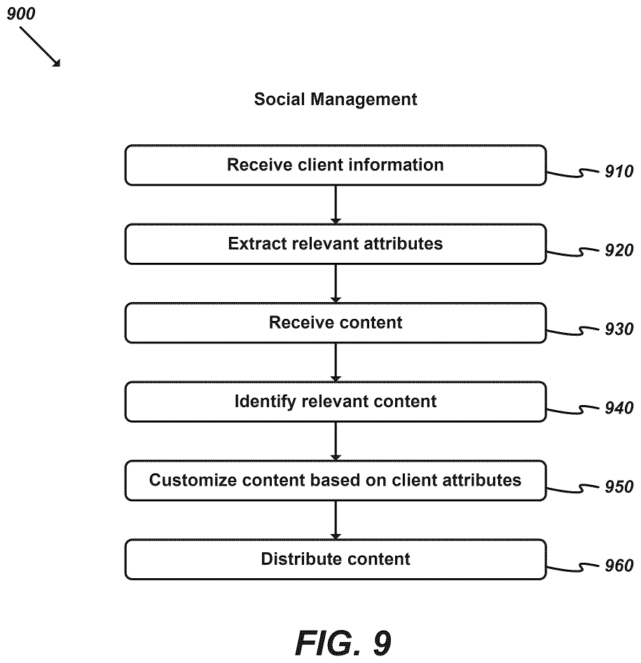

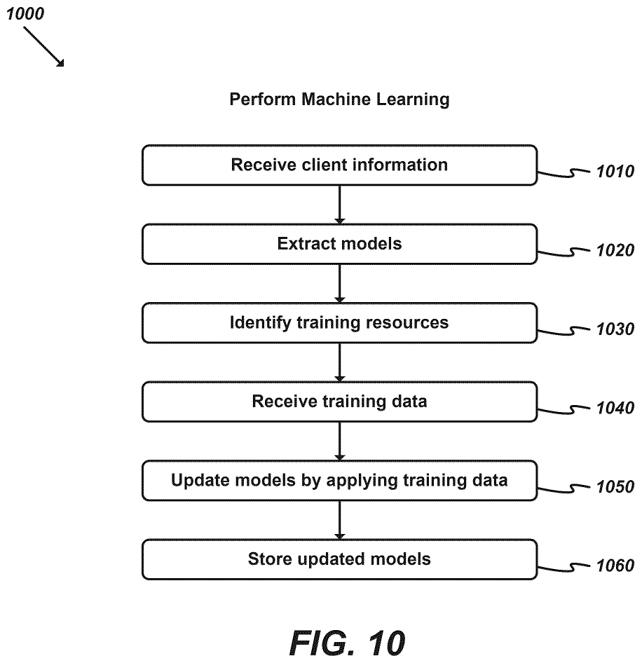

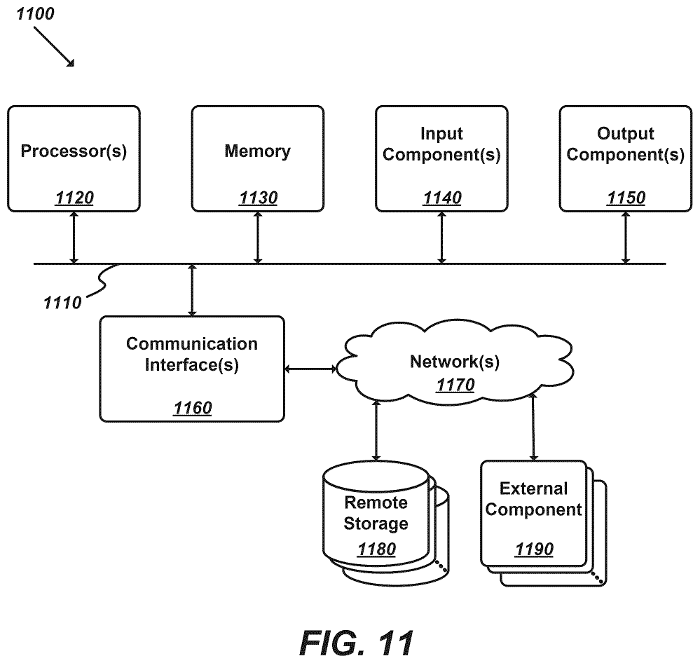

FIG. 6 illustrates an example process 600 for providing a dashboard of some embodiments. The process 600 may generate the user interface that allows interaction with a client 100, such as collection of client information, provision of feedback, etc. The process 600 may be performed whenever a client 105 accesses the DFA 100 via dashboard 110. In some embodiments, process 600 may be performed by DFA 100.

As shown, process 600 may include receiving (at 610) client information. Such client information may be extracted from an element such as a client profile or client data element 210. Client information may include preference or settings indicated by the client profile.

Process 600 may include identifying (at 620) dashboard components. DFA 100 may provide a listing of available dashboard components and/or a listing of components that are enabled or activated for the client 105. As described above, the dashboard 110 may include components or sub-platforms such as a content, analytics, call tracking, reputation management, social management, and support. Depending on various relevant factors (e.g., industry, goods and/or services, client preferences, etc.) some or all sub-platforms may be utilized or enabled.

The process 600 may include generating (at 630) a GUI that provides access to the various identified dashboard components. The GUI may be, utilize, and/or be implemented via a resource such as a web site or smart device app. The GUI may include various input/output components, such as display areas, selection menus, buttons, links or other references, etc. The GUI may allow clients 105 to make selections and/or otherwise enter data. The GUI elements may be utilized to provide or implement functionality of the DFA 100. For example, the GUI may present an interview script to a client 105 and capture audiovisual data from the client 105 in response (e.g., via a camera and microphone of user device 320.

As shown, process 600 may include receiving (at 640) input from the client. Various selections or data entries may be received via the GUI. Inputs may include, for example, selections or preferences, captured multimedia (e.g., text, audio, video, image data, etc.), and/or other appropriate information.

Process 600 may include updating (at 650) the dashboard 110 based on the received input. The dashboard 110 may be updated in various appropriate ways depending on the received inputs. For example, if a client 105 selects an “analytics” tab or button, information related to analytics may be provided. As another example, if a client 105 selects a “content” tab or button, options related to interview scripts, services pages, blog posts, and/or a resource library may be provided.

FIG. 7 illustrates an example process 700 for generating content for a client. The process 700 may be used to generate, for example, multimedia content that will be distributed to various presentation resources 120 (e.g., one or more websites, emails, social media platforms, etc.). The process 700 may be performed when a client 105 makes a selection, when a rule 160 or policy indicates that content should be automatically generated, and/or under other appropriate circumstances (e.g., when a relevant template is released and/or updated). In some embodiments, process 700 may be performed by DFA 100.

As shown, process 700 may include generating (at 710) an interview script. The interview script may be generated using a process such as process 800.

Process 700 may include providing (at 720) prompt(s) to appropriate resources. Such prompts may be provided to resources such as, for example, client 105 or component generator 115. A prompt may include, for instance, a text or audio question (e.g., a FAQ) that may be presented to the client 105 and/or a component generator 115 such as a template library, industry professional, etc.

The process 700 may include capturing (at 730) responses to the prompts. Responses may be captured in different ways depending on the respondent and/or other relevant factors. For example, responses from a client 105 may be captured via a camera and microphone of a user device 320. As another example, responses may be received from component generators 115 via various messaging protocols. As another example, an entry in a lookup table or database may provide information that is responsive to a prompt.

As shown, process 700 may include filtering and editing (at 740) responses to the prompts. Such filtering and/or editing may depend on the attributes of a particular response. For instance, a recorded video response may be edited to remove sections of silence or indecipherable speech. As another example, feedback may be received from the client 105 as to which responses are applicable or preferred.

Process 700 may include generating (at 750) multimedia content based on the responses. Multimedia content may be generated in various appropriate ways depending on the type of content, presentation resource attributes, and/or other relevant factors. For example, audiovisual content may be rendered to different file types with different attributes (e.g., size, resolution, etc.) depending on the capabilities of the presentation resources 120. As another example of generating multimedia content, a tokenized template may be populated with client-specific information and/or may be otherwise customized (e.g., based on inputs received from client 105, based on machine learning models, rules, or policies, etc.).

The process 700 may include distributing (at 760) the multimedia content to various presentation resources 120. Content may be distributed in various appropriate ways. For instance, audiovisual content may be uploaded to a content server. As another example, text content may be provided to a resource such as a blog site. As still another example, an image may be automatically uploaded or posted to a social media site.

Multimedia content may be tagged or annotated in various ways (e.g., via metadata). Tor instance, each content item (e.g., an audiovisual file or data stream) may be associated with various keywords, FAQs, client-related information (e.g., industry), and/or other appropriate information. Such content may be stored to a server or other resource associated with DFA 100 such that the content may be utilized by other clients 105 (e.g., a client 105 may modify a template provided by a different client 105 or utilize a captured response from a different client 105).

FIG. 8 illustrates an example process 800 for generating an interview script of some embodiments. The process 800 may select from among available FAQs (and/or other script content) to generate a listing of prompts. The process 800 may be performed at operation 710 of process 700. In some embodiments, process 800 may be performed by DFA 100.

As shown, process 800 may include receiving (at 810) a listing of resources. The listing of resources may include, for example, a listing of identifiers of relevant component generators 115 and/or research resources (e.g., online databases).

Process 800 may include receiving or extracting (at 820) relevant attributes. Relevant attributes may be related to the client 105, resource (e.g., a particular component generator 115), industry, goods and/or services, etc.

The process 800 may include identifying (at 830) FAQs. FAQs may be identified based on the extracted attributes. A listing of FAQs may be generated based on information related to the industry, client 105, region, services, and/or other relevant attributes. The listing of FAQs may be filtered or modified based on factors such as client preferences, engagement data, potential distribution channels, etc. For example, a list of FAQs associated with a veterinary practice may be filtered depending on the types of animals for which the veterinary practice provides care. As another example, FAQs associated with a particular treatment or medication may be eliminated if the treatment or medication is not offered by the veterinary practice. The order of FAQs in the listing may be updated based on various factors. For instance, each FAQ may be analyzed to generate a score or metric indicating the relevance of the FAQ to the particular client 105, industry, etc. and the listing of FAQs may be sorted based on the metric or score.

As shown, process 800 may include generating (at 840) a list of FAQs. The filtered list of FAQs may be saved to a file or other data structure (e.g., as a listing of FAQ identifiers).

FIG. 9 illustrates an example process 900 for managing social engagement in some embodiments. The process 900 may provide ways to identify relevant content and distribute the content to appropriate social media resources. The process 900 may be performed at regular intervals, whenever updated content becomes available, and/or under other appropriate circumstances. In some embodiments, process 900 may be performed by DFA 100.

As shown, process 900 may include receiving (at 910) client information. Such client information may be extracted from an element such as a client profile or client data element 210. Client information may include preference or settings indicated by the client profile.

Process 900 may include extracting (at 920) relevant attributes. Such attributes may include industry, goods and/or services, client preferences, social media platform, etc.

The process 900 may include receiving (at 930) content. Content may be received from a storage or database, such as content and/or resources 125 managed by DFA 100.

As shown, process 900 may include identifying (at 940) relevant content. Depending on the relevant attributes, content may be identified or selected. For example, if a particular service is popular on a social media platform of interest, content associated with that service may be more likely to be selected for distribution to the social media platform of interest.

Process 900 may include customizing (at 950) the content based on client attributes. Such customization may include, for instance, replacing tokenized data with client-specific information.

The process 900 may include distributing (at 960) the content to various social media presentation resources 120. Content may be distributed in various appropriate ways.

FIG. 10 illustrates an example process 1000 for performing machine learning in some embodiments. The process 1000 may be used to optimize elements such as rules 160 based on training data. The process 1000 may be performed at regular intervals, when training data becomes available, and/or under other appropriate circumstances. In some embodiments, process 1000 may be performed by DFA 100.

As shown, process 1000 may include receiving (at 1010) client information. Such client information may be extracted from an element such as a client profile or client data element 210. Client information may include preference or settings indicated by the client profile.

Process 1000 may include extracting (at 1020) machine learning models associated with the client 105. Such machine learning models may be associated with the client in various different ways. For instance, a set of models may be associated with a particular industry, region, service, etc. Machine learning models may be used to analyze performance, generate feedback, generate content, select distribution paths, and/or otherwise implement the functionality of DFA 100.

The process 1000 may include identifying (at 1030) training resources. Training resources may include sources of training data, such as social media platforms, websites, analytics resources, e-commerce sites, etc. For example, presentation resources 120 may provide feedback that may be used as training data by the DFA 100. As another example, the DFA 100 may provide training data related to analytics or other dashboard sub-platforms (e.g., reputation management, review management, etc.).

As shown, process 1000 may include receiving (at 1040) training data. Training data, such as client feedback, consumer actions, engagement, and/or other appropriate data may be received from the various training resources. In some embodiments, training data (and/or any associated machine learning models), may be associated with a specific client 105 (i.e., the data may not be shared with other clients 105 nor used to train machine learning models used by other clients). In other embodiments, training data and/or machine learning models may be shared among clients 105 (e.g., new clients 105 from a given industry may be provided with default machine learning models for that industry).

Process 1000 may include updating (at 1050) the machine learning models by applying the training data. For instance, if training data indicates that a first blog post template resulted in more engagement than a second blog post template, the model may be more likely to select the first blog post template in the future. As another example, if a first type of content (e.g., video) results in more sales or books than a second type of content (e.g., text), the machine learning model may be more likely to recommend creation of the first type of content in the future.

The process 1000 may include storing (at 1060) updated models. DFA 100 may store the updated models (and/or generate new models, as appropriate) to a resource such as storage 330.

One of ordinary skill in the art will recognize that processes 400-1000 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

FIG. 11 illustrates a schematic block diagram of an exemplary device (or system or devices) 1100 used to implement some embodiments. For example, the systems, devices, components, and/or operations described above in reference to FIG. 1 may be at least partially implemented using device 1100. As another example, the processes described in reference to FIG. 4, FIG. 6, FIG. 7, FIG. 8, FIG. 9, and FIG. 10 may be at least partially implemented using device 1100.

Device 1100 may be implemented using various appropriate elements and/or sub-devices. For instance, device 1100 may be implemented using one or more personal computers (PCs), servers, mobile devices (e.g., smartphones), tablet devices, wearable devices, and/or any other appropriate devices. The various devices may work alone (e.g., device 1100 may be implemented as a single smartphone) or in conjunction (e.g., some components of the device 1100 may be provided by a mobile device while other components are provided by a server).

As shown, device 1100 may include at least one communication bus 1110, one or more processors 1120, memory 1130, input components 1140, output components 1150, and one or more communication interfaces 1160.

Bus 1110 may include various communication pathways that allow communication among the components of device 1100. Processor 1120 may include a processor, microprocessor, microcontroller, DSP, logic circuitry, and/or other appropriate processing components that may be able to interpret and execute instructions and/or otherwise manipulate data. Memory 1130 may include dynamic and/or non-volatile memory structures and/or devices that may store data and/or instructions for use by other components of device 1100. Such a memory device 1130 may include space within a single physical memory device or spread across multiple physical memory devices.

Input components 1140 may include elements that allow a user to communicate information to the computer system and/or manipulate various operations of the system. The input components may include keyboards, cursor control devices, audio input devices and/or video input devices, touchscreens, motion sensors, etc. Output components 1150 may include displays, touchscreens, audio elements such as speakers, indicators such as light-emitting diodes (LEDs), printers, haptic or other sensory elements, etc. Some or all of the input and/or output components may be wirelessly or optically connected to the device 1100.

Device 1100 may include one or more communication interfaces 1160 that are able to connect to one or more networks 1170 or other communication pathways. For example, device 1100 may be coupled to a web server on the Internet such that a web browser executing on device 1100 may interact with the web server as a user interacts with an interface that operates in the web browser. Device 1100 may be able to access one or more remote storages 1180 and one or more external components 1190 through the communication interface 1160 and network 1170. The communication interface(s) 1160 may include one or more APIs that may allow the device 1100 to access remote systems and/or storages and also may allow remote systems and/or storages to access device 1100 (or elements thereof).

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1100 may perform various operations in response to processor 1120 executing software instructions stored in a computer-readable medium, such as memory 1130. Such operations may include manipulations of the output components 1150 (e.g., display of information, haptic feedback, audio outputs, etc.), communication interface 1160 (e.g., establishing a communication channel with another device or component, sending and/or receiving sets of messages, etc.), and/or other components of device 1100.

The software instructions may be read into memory 1130 from another computer-readable medium or from another device. The software instructions stored in memory 1130 may cause processor 1120 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

1. A device, comprising:
one or more processors configured to:
provide a dashboard to a client;
receive, via the dashboard, industry information related to the client;
identify a set of search terms based at least partly on the industry information; and
generate an industry profile based at least partly on the set of search terms.

2. The device of claim 1, wherein the industry profile comprises a listing of frequently asked questions (FAQs) associated with the set of search terms.

3. The device of claim 2, the one or more processors further configured to:
generate an interview script based at least partly on the listing of FAQs;
provide, via the dashboard, a prompt for each FAQ in the listing of FAQs; and
capture a response to the prompt.

4. The device of claim 3, wherein each of the responses comprises audiovisual content of the client.

5. The device of claim 3, the one or more processors further configured to:
generate multimedia content based at least partly on the responses; and
distribute the multimedia content to at least one presentation resource.

6. The device of claim 5, wherein generating the interview script comprises applying a machine learning model to the listing of FAQs.

7. The device of claim 6, the one or more processors further configured to:
collect feedback from the at least one presentation resource; and
train the machine learning model based at least partly on the collected feedback.

8. A non-transitory computer-readable medium, storing a plurality of processor-executable instructions to:
provide a dashboard to a client;
receive, via the dashboard, industry information related to the client;
identify a set of search terms based at least partly on the industry information; and
generate an industry profile based at least partly on the set of search terms.

9. The non-transitory computer-readable medium of claim 8, wherein the industry profile comprises a listing of frequently asked questions (FAQs) associated with the set of search terms.

10. The non-transitory computer-readable medium of claim 9, the plurality of processor-executable instructions further to:
generate an interview script based at least partly on the listing of FAQs;
provide, via the dashboard, a prompt for each FAQ in the listing of FAQs; and
capture a response to the prompt.

11. The non-transitory computer-readable medium of claim 10, wherein each of the responses comprises audiovisual content of the client.

12. The non-transitory computer-readable medium of claim 10, the plurality of processor-executable instructions further to:
generate multimedia content based at least partly on the responses; and
distribute the multimedia content to at least one presentation resource.

13. The non-transitory computer-readable medium of claim 12, wherein generating the interview script comprises applying a machine learning model to the listing of FAQs.

14. The non-transitory computer-readable medium of claim 13, the one or more processors further configured to:
collect feedback from the at least one presentation resource; and
train the machine learning model based at least partly on the collected feedback.

15. A method comprising:
provide a dashboard to a client;
receive, via the dashboard, industry information related to the client;
identifying a set of search terms based at least partly on the industry information; and
generating an industry profile based at least partly on the set of search terms.

16. The method of claim 15, wherein the industry profile comprises a listing of frequently asked questions (FAQs) associated with the set of search terms.

17. The method of claim 16 further comprising:
generating an interview script based at least partly on the listing of FAQs;
providing, via the dashboard, a prompt for each FAQ in the listing of FAQs; and
capturing a response to the prompt.

18. The method of claim 17, wherein each of the responses comprises audiovisual content of the client.

19. The method of claim 17 further comprising:
generating multimedia content based at least partly on the responses; and
distributing the multimedia content to at least one presentation resource.

20. The method of claim 19 further comprising:
at least partly generating the interview script by applying a machine learning model to the listing of FAQS;
collecting feedback from the at least one presentation resource; and
training the machine learning model based at least partly on the collected feedback.
